(19) United States
(12) Patent Application Publication
(10) Pub. No.: US 2011/0175393 A1
(43) Pub. Date: Jul. 21, 2011

(54) Aerodynamic boat tail attachment

(76) Inventor: William Chester Cline, Moe (AU)

(21) Appl. No.: 12/903,207

(22) Filed: Oct. 13, 2010

(30) Foreign Application Priority Data
Oct. 27, 2009 (AU) 2009230771

(51) Int. Cl. B62D 37/02

(52) U.S. Cl. 296/180.1

(57) ABSTRACT

An aerodynamic boat tailed attachment is disclosed. The attachment is a flexible membrane 2 attached to a frame 3 that is inflated to an aerodynamic shape by the forces of the air pressures flowing past and or into the mechanism. The shape may be further controlled by flexible stays 9 as required. The attachment reduces aerodynamic drag on rectangular vehicles and trailers. The attachment can be pivoted to another position for access.

This invention is an improved aerodynamic boat tail attachment for trucks and trailers.

Trucks and trailers often need to be rectangular in shape. Truck styles that are rectangular include refrigerated trucks, pantecs, curtainsiders, furniture removalists, chip trucks, tip or dump trucks, etc. Shipping containers a re also rectangular loads. Caravans or house trailers are another substantially rectangular unit. Aerodynamic panels like nose cones, fuel scoops, cab extenders, and side skirts are well documented and accepted methods or attachments that improve air flow. Improved air flow lowers fuel use, lowers emissions, and improves drivability.

The air flow over the trailing or rear of these substantially rectangular units creates a vacuum and turbulence. Attaching a ‘boat tail’ shaped appendage is a proven method of reducing this vacuum and turbulence, and improving aerodynamics.

Conventional ‘boat tail’ attachments are relatively solid panels or shapes that are not user friendly. Most rectangular truck bodies are loaded and unloaded from the rear. Hence any attachment must hinge to swing out of the way, or must be easy to remove. Existing systems are not easy to use. A practical boat tail also needs to be light weight, to maximize payload. Truck and trailer overall length is controlled by law. Therefore, any extension to the length must either meet some government requirement, like the USA allowance for aerodynamic aids of five feet, or be collapsible to minimize effective length.

These problems are overcome by the present invention, which is a user friendly aerodynamic boat tail attachment consisting of a flexible membrane that inflates by the forces of the air pressures flowing past and or into the mechanism to provide the correct aerodynamic shape.

Stays or reinforcements attached to or retained by pockets in the flexible membrane may help maintain the shape, if required.

The flexible membrane may be canvas, plastic, or any other reasonably robust material.

The membrane is attached to a semi rigid perimeter frame that is hinged either horizontally or vertically to allow the boat tail to be swung either out of the way, or upright to provide shelter or assist in any other means.

One form of this ‘boat tail’ is herein described. A steel tube perimeter frame is hinged on one side of the rear doors on the rear of the body. Locking devices maintain the correct position for travel. The canvas membrane is sewn into a curved pyramid shape, with the base attached to the perimeter frame. An air scoop protrudes into the air flow slightly to obtain some positive pressure which helps the air flow over the external part of the membrane suck it out into the correct boat tail shape as vehicle speed increases.

This boat tail shape fills in the void behind the rectangular body, guiding the air flow smoothly to rejoin with the minimum of drag causing vacuum and turbulence. As the vehicular speed reduces, air flow and pressure reduces, and the canvas membrane collapses to minimize overhang and truck overall length.

This invention is easy to swing right around out of the way, is inobtrusive, and doesn't detract from over all looks.

The flexible membrane can be nearly any flexible material. The supporting frame can be steel, fiberglass, high tech plastic, or other material that structurally is sound. Overall shape depends upon the required product needs. Hinges can be a flexible member, or rigid structure, as required and as most suitable to the fitment. Permanent fixing may be appropriate on some installations. A scoop may not be needed, as high speed air flowing past a surface causes a low pressure or vacuum to be formed which may be sufficient to properly shape the membrane. A resilient strap/s or strut/s may be required to add control in either the inflated/extended or deflated/collapsed positions. The resilient strap or strut may be rubber, plastic, or any other form or resilient unit, such as a spring. The shape of the membrane may be altered into a truncated form, more geometric form, a circular form, or other form as required by the installation.

To assist understanding of this invention, reference will now be made to the accompanying drawings of one example of the invention:

In the drawings:

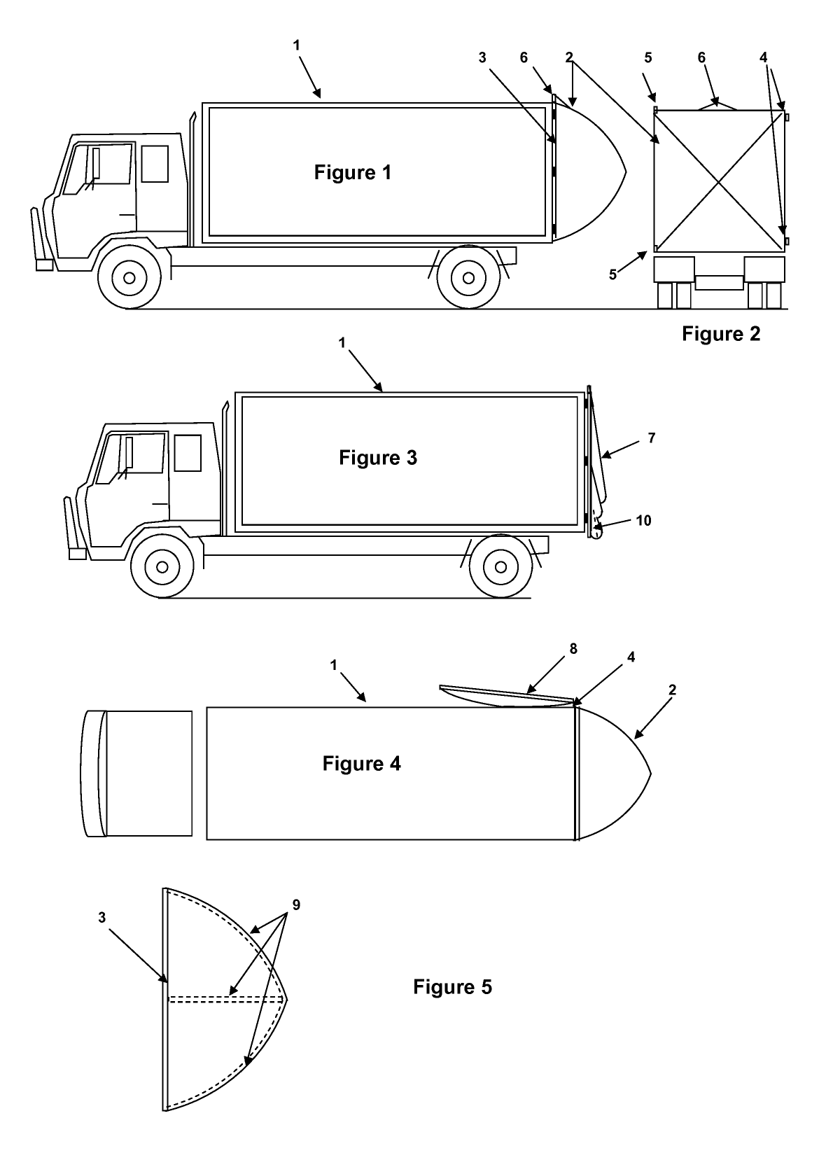

FIG. 1 shows one example of this invention where the boat tail device is attached to the rear end of a typical rectangular body on a truck;

FIG. 2 shows the rear view of this boat tail invention as mounted on the truck;

FIG. 3 shows this boat tail invention in the approximate collapsed shape as when the truck is stationary;

FIG. 4 is a vertical view of the boat tail invention as attached to the rear end of a typical truck, and as it would be when stationary, with the boat tail invention swung sideways for access to the rear of the truck;

FIG. 5 is a side view of the boat tail invention by itself, with steel frame, and the stay pockets shown.

The aerodynamic boat tail attachment membrane 2 is attached to a metal frame 3 which is attached to the truck body 1 by hinges 4 and locking devices 5. This firmly attaches the aerodynamic boat tail attachment to the truck to aid aerodynamics when travelling at speed. The aerodynamic boat tail consists of a flexible membrane, the ‘at speed’ outline as shown by 2. Air flow entering the air scoop 6 helps the reduced pressure of high speed air flow over the attachment membrane 2 to induce the correct aerodynamic shape of the membrane as shown in FIGS. 1, 4, and 5. When the vehicle slows sufficiently, or stops, the aerodynamic boat tail attachment collapses as shown in FIG. 3 at 7. When access to the rear of the truck is required, the aerodynamic boat tail attachment swings around hinges 4 to an unobtrusive position along the side of the truck body as shown at 8 in FIG. 4. Pockets or loops 9 sewn or attached to the main membrane may be necessary to house flexible stays for extra shape stability. Tension members 10 may be needed to control the collapsed membrane shape when stationary or at low speeds.

The claims defining the invention are as follows:

1. An aerodynamic boat tail attachment consisting of a flexible membrane that inflates by the forces of the air pressures flowing past and or into the mechanism to provide the correct aerodynamic shape.

2. An aerodynamic boat tail attachment of claim 1 wherein added flexible stays are inserted or attached to improve or control the shape.

3. An aerodynamic boat tail attachment of claim 1 wherein a rigid frame supports and attaches the flexible membrane as required.

4. An aerodynamic boat tail attachment of claim 1 wherein the rigid frame is attached with hinges and locking devices to allow the attachment to be pivoted to another position.

5. An aerodynamic boat tail attachment of any claims 1 to 4 where in a flexible resilient tension member/s controls the membrane form when collapsed for visual or legal needs.

6. An aerodynamic boat tail attachment substantially as herein described with reference to the accompanying drawings.
